(19) United States
(12) Patent Application Publication
(10) Pub. No.: US 2010/0030121 A1
(43) Pub. Date: Feb. 4, 2010

(54) Massage Chair Servo

(76) Inventor: Wei Fu, Jiaxing City (CN)

Correspondence Address: LAW OFFICES OF BIN LI & ASSOCIATES, SUITE 605, 17800 CASTLETON STREET, CITY OF INDUSTRY, CA, 91748, US

(21) Appl. No.: 12/182,134

(22) Filed: Jul. 30, 2008

(51) Int. Cl. A61H 7/00

(52) U.S. Cl. 601/99

(57) ABSTRACT

This new invention is a frame and servo assembly for attaching to massage chair seats manufactured without an existing servo assembly. It includes a frame body, on which there is sliding rack, a screw drive, a positioning stabilizer bar, and a connecting plate. The sliding rack is coupled to various motor brackets, the screw drive, a driving block, a screw drive stop block, and a plurality of wave shaped massaging wheels. The various motor brackets are coupled to two motors. One of the motors utilizes an axle with an off-center axis on both ends. There are multiple connecting brackets installed on the off-center axle, with wheel brackets installed at the end of the connecting brackets. Various “wave” shaped wheels at the end of the wheel brackets aid to simulate the natural feel of human hand joint movements to a user. At the two ends of the additional motor assemblies are bases for joint assemblies. These joint bases are connected to the connecting brackets via connecting joints. The wheels are located on the two ends of the sliding rack. The positioning stabilizer bar is affixed inside the frame body for stability.

### BACKGROUND OF THE INVENTION

1. Field of the Invention

This present invention relates to the field of massage chairs and specifically to a multi-functioning massage chair frame and servo assembly.

2. Brief Description of the Related Art

The existing massage chair frames and servo assembly racks presently in the market now, when in use, have problems of poor adaptation to the multiplicity and variety of chairs on the market, thereby causing unstable and wobbling in movement and creating a poor massage effect.

The existing massage chair frames and servo assembly racks on the market today have a number of problems such as: poor compatibility in installation causing very shaky movements during operation, and the effect of leaving a user with a massage feeling too far remote from the natural, relaxing and pleasant contour of real hand massages.

This is due to the inconvenient connection and positioning of these massage chair frames with respective massage chairs on the market. This is in addition to the improper design of the massage parts and instability in connections and functions thereby leaving only a small area of effective massage for which to comfort a user. This present invention solves these problems.

### SUMMARY OF THE INVENTION

This present invention is a frame and servo assembly for massage chair seats manufactured without an existing servo assembly. It includes a frame body, on which there is sliding rack, a screw drive, a positioning stabilizer bar, and a connecting plate.

The sliding rack is coupled to various motor brackets, the screw drive, a positioning stabilizer bar, a driving block, a screw drive stop block, and a plurality of massaging wheels. The massaging wheels of the present invention incorporate “wave” indentations to provide for kneading massage motions similar to a hand massage and yet provide for smooth rolling resistance.

There are two motors on the various motor brackets. One of the motors utilizes an axle with an off-center axis on both ends. There are multiple connecting brackets installed on the off-center axle, with wheel brackets installed at the end of the connecting brackets. Various “wave” shaped wheels at the end of the wheel brackets aid to simulate the natural feel of human hand joint movements to a user.

At the two ends of the additional motor assemblies are bases for joint assemblies. These joint bases are connected to the connecting brackets via connecting joints.

The wheels are located on the two ends of the sliding rack. The positioning stabilizer bar is affixed inside the frame body for stability.

The screw drive is screwed within the screw drive driving block and screw drive stop block.

The positioning stabilizer bar and the two wheels on both ends of the sliding rack form a three (3) point junction at that location.

Two (2) connecting plates are located on both sides of the frame body. These connecting plates may be attached to any massage chairs with universal “KD” (Knock Down) brackets. Most massage chair assemblies on the market today require a massage chair servo assembly installed before becoming a massage chair. Without installation of such massage chair servo assemblies, as in the present invention, such chairs would simply be chairs and not massage chairs. Such chairs utilize the standard KD bracket system to accommodate coupling to limited choices of massage servo assemblies on the market today.

This present invention is a massage chair servo assembly that utilizes a universal KD bracket that allows for fitment with virtually all ready to install chairs. Therefore this present invention is very convenient for manufacturers and assemblers as it may be used with various motion chair systems on the market. Such convenience limits the quantities of stock and inventory that one manufacturer must carry on hand.

By limiting the requirement of having to have a different massage chair servo assembly for each different type of ready to install chair, manufacturers will be able to reduce overhead by reducing the quantity of servo assemblies required to have on stock to meet demands for each different type of chair. With this present invention, manufacturers will only need to carry one type of servo assembly to fulfill the demand of each different chair manufacturer in making such chairs into massage chairs.

Additional characteristics of the present invention is its wide range of actual and usable massaging area. The wide range of usable massage area enables a user to select combination of massage spots at each user's choice. Such combinations include but are not limited to providing for smooth massage movement, and reproducing movements similar to human hands, therefore providing for an effective resulting massage.

The wide variety of massage combinations possible by the present invention are one of its many features, in addition its easy connection to a variety of chairs, easy positioning, and easy adaptation for use with various chairs assemblies.

The purpose of the patent is to provide a massage chair servo assembly easily attachable to a multiple variety of massage chairs.

The patent intends to solve the problem caused by the existing improper designs on the market today, which includes poor adaptation, poor massage effect, and wobbling in movement, and inconvenience in connecting and positioning to variety of chairs.

The above technical solution is as follows:

This new massage servo assembly includes a Main Rack, two sides of the Main Rack are loaded with various options for connections within the unit which can readily be connected to various multi-function chair systems.

The Sliding Rack is installed in the Main Rack and movable up and down through the screw drive bar. There are two motors and two rolling wheel support brackets installed on the Sliding Rack, the massage function is achieved by the movement of the Rolling Massaging Wheels.

The positioning of the Sliding Rack during movement is accomplished by the positioning system which consists of two Slide Rail Wheels on both the Left and Right side providing for frictionless upward and downward motion. Fitted through the Sliding Rack is a Positioning Stabilizer Bar. This design utilizing both a Screw Drive and a Stabilizer Bar allows for smooth and stable upward and downward motions during operation. Utilizing the additional stabilizer bar helps eliminate the problems of shakiness and wobbling observed in other existing massage systems as they exist on the market today without these features.

In addition, the Rolling Massage Wheels adopt a “wave” shape thereby producing massaging motions similar to the human hand joint structure, to simulate the very strong hand massage which no other massage systems on the market today can produce.

The servo includes the frame body, on which there is sliding rack, screw drive, positioning stabilizer bar, and slide rail wheels on both sides. On the sliding rack, there are motor bracket assemblies, screw drive driving block, screw drive stop block, and the plurality of wheels. There are two motors on the motor bracket, one of the motors incorporates an off-center axis axle on both ends. There are connecting brackets installed on the off-center axle, and wheel brackets installed at the end of the connecting bracket, and wave shaped wheels at the end of the wheel bracket, thus simulating the human hand joint movement and the human hand feeling during operation. At the two ends of the other motor are joint bases. The joint bases are connected to the connecting brackets via connecting joints. The slide rail wheels are located on the two ends of the sliding rack. The positioning stabilizer bar is affixed inside the frame body. The screw drive is screwed within the screw drive driving block and screw drive stop block. The positioning stabilizer bar and the two wheels on both ends of the sliding rack form the 3 point location. The KD Bracket connecting plates are located on both sides of the frame body, the KD Bracket connecting plates can make connection to any KD brackets of any such chairs on the market, thus is very convenient for use with a variety of various motion chair systems.

The advantages of this patent is its wide range of massage area, selective massage spots of a user's choice, smooth massaging movement, thereby creating an effective massage result.

These and other variations are intended to be within the scope of the invention.

In all embodiments of the present invention, the novel features that are considered characteristic of this invention are set forth with particularity in the appended claims. The invention will best be understood from the following description when read in connection with the accompanying drawings.

Still other objects, features, and attendant advantages of the present invention will become apparent to those skilled in the art from a reading of the following detailed description of embodiments constructed in accordance therewith, taken in conjunction with the accompanying drawings.

### BRIEF DESCRIPTION OF THE DRAWINGS

FIG. 1 shows the front, right and bottom side of the massage chair servo (with various parts removed to outline detail).

FIG. 2 shows the rear, left and top side of the massage chair servo.

FIG. 3 is a front view of the massage chair servo.

FIG. 4 is a front, right and bottom view of the massage chair servo with sliding rack assembly (30) and percussion motor assemblies (31) removed.

FIG. 5 is a front, right and bottom view of the massage chair servo with sliding rack assembly (30) removed, rolling wheel assemblies (80) removed, percussion motor assemblies removed (31), screw drive (60) removed, stabilizer bar (61) removed, vertical motor (40) removed, stop switches (41) removed and wiring loom (41) removed, showing only the massage servo frame structure (51) and KD bracket connecting plates (50).

FIG. 6 shows the screw drive (60) of the massage chair servo removed from assembly.

FIG. 7 shows the stabilizer bar (61) of the massage chair servo removed from assembly.

FIG. 8 is an exploded view of sliding rack assembly (30) with details of percussion motor assemblies (31), and roller wheel assemblies (80).

FIG. 9 is an exploded view of a roller wheel assembly (80).

FIG. 10 is an exploded view of a massaging wheel assembly (91).

FIG. 11 is an exploded view of a pivot joint assembly (92).

FIG. 12 is a rear, left, bottom view of the massage chair servo assembly in exploded view with all parts shown in detail.

### DESCRIPTION OF PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner. Referring to the drawing figures, like reference numerals designate identical or corresponding elements throughout the several figures.

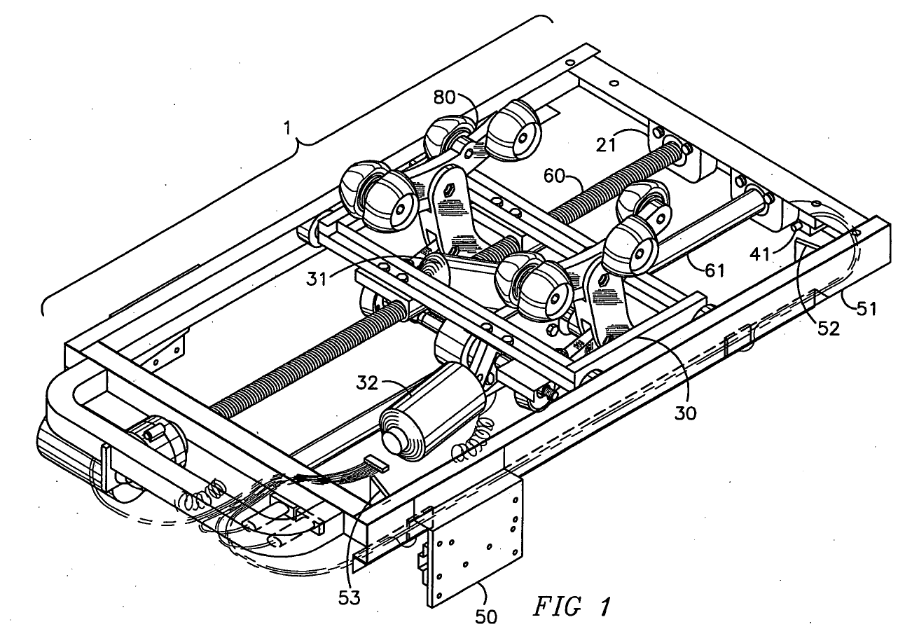

In accordance with a preferred embodiment of the invention, there is disclosed Within FIG. 1, a front, right and bottom view with a massage chair servo main rack (1) massage chair servo frame body (51), there is a sliding rack assembly (30), screw drive (60), positioning stabilizer bar (61), various stop switches (41), roller wheel assemblies (80), upper percussion motor assembly (31), lower percussion motor assembly (32) and KD Bracket connecting plates (50). On the frame structure (51) the upper screw drive stop block (52) limits further movement of sliding rack assembly (30) from moving past position on top, the lower screw drive stop block (53) limits further movement of sliding rack assembly (30) from moving past position on lower bottom end. Each roller wheel assembly (80) of FIG. 1 is coupled to four (4) roller massaging “wave” shaped wheels (81). There are axle connecting rods (94) installed on the off-center axis axles (93). The pivot lever (82) is installed at the end of the pivot arm (83). The four (4) wave shaped massaging wheels (81) are installed at the end of the pivot level (82). The roller wheel assembly (80) incorporates the pivot arm (83), pivot lever (82) and four (4) wave shaped massaging wheels (81) installed on the pivot level (82). The roller massaging wheels (81) adopt joint structures similar to human hands and thus simulate the human hand joint movement when the whole servo system is functioning together.

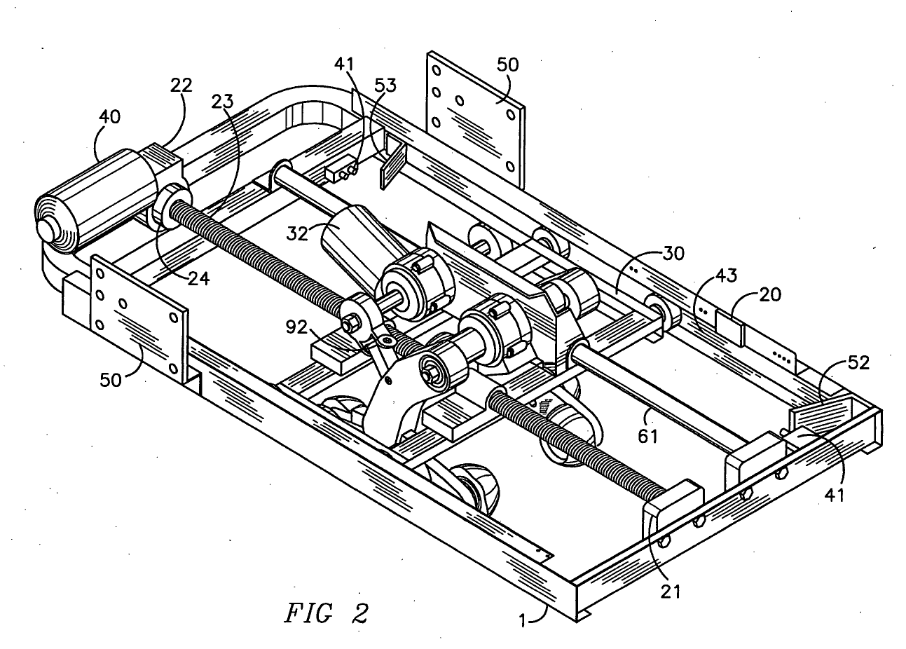

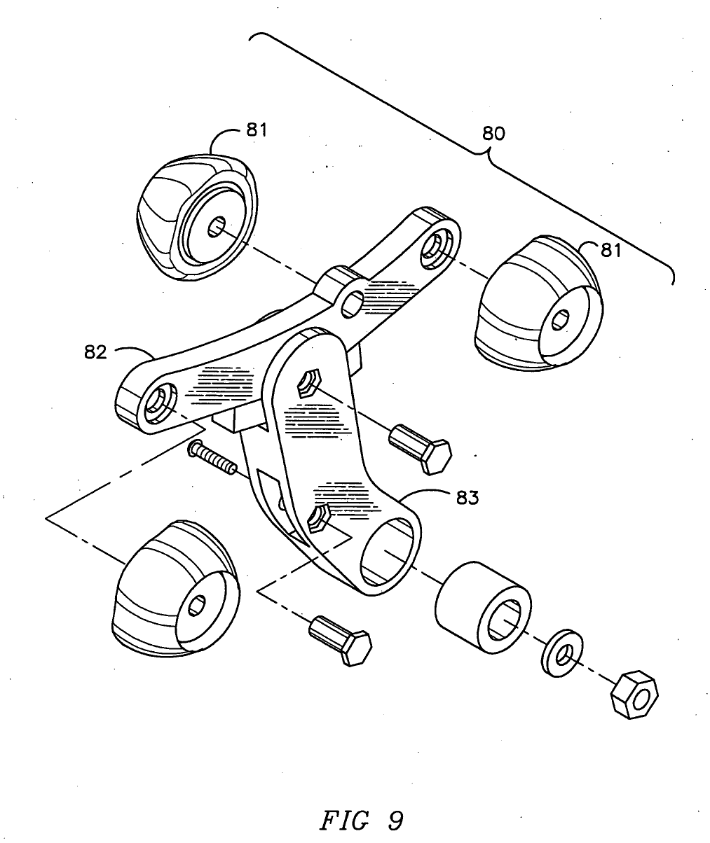

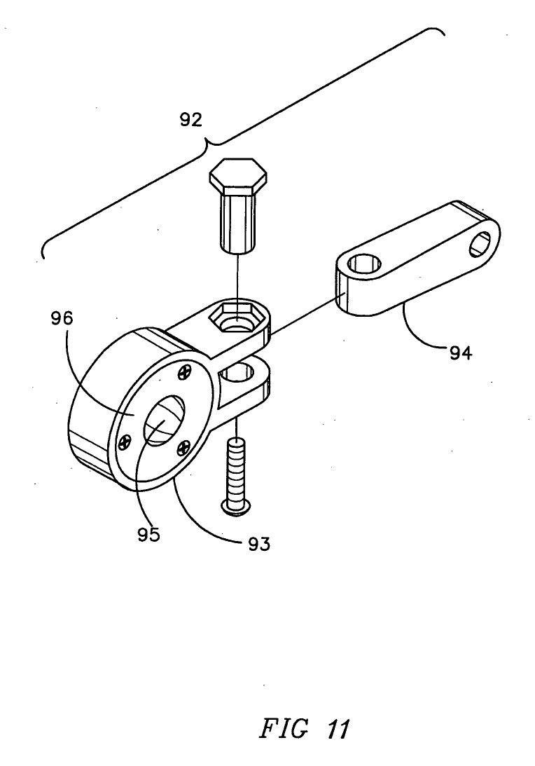

The rear, left and top view of the present invention as is shown in FIG. 2 shows that at the two ends of the lower percussion motor assembly (32) there are pivot joints (92). The pivot joints (92) comprise of the off center axis axle (93) and the axle connecting rod (94), the off center axis axle (93) comprise of a ball joint (95) which is covered by the joint lid (96) as seen in FIG. 11. The off center axis axle (93) is connected to the pivot arm (83) of FIG. 9 via the axle connecting rod (94). The upper percussion motor assembly (31) is also connected to pivot joints (92). Screw drive (60) as shown in FIG. 2 terminates its upward movement at upper screw drive stop block (52) and terminates lower downward movement at lower stop block (53). Motion of sliding rack (30) in upward and downward movement is accomplished via screw drive (60) and is reversed by stop switches (41) at the same position as upper screw drive stop block (52) and terminates at the corresponding bottom position at lower stop block (53). Stabilizer bar (61) provides stability as sliding rack (30) is moved upwards and downwards along slide rail guides (43) via slide rail wheels (70). Position of sliding rack (30) is measured by position regulator (20). Screw drive (60) provides movement with the vertical motor assembly (40) with screw drive gear (23) and motor support lid (24) coupled to screw drive driving block (22) on bottom end of assembly (1) and to screw drive fixing block (21) on upper end of assembly (1).

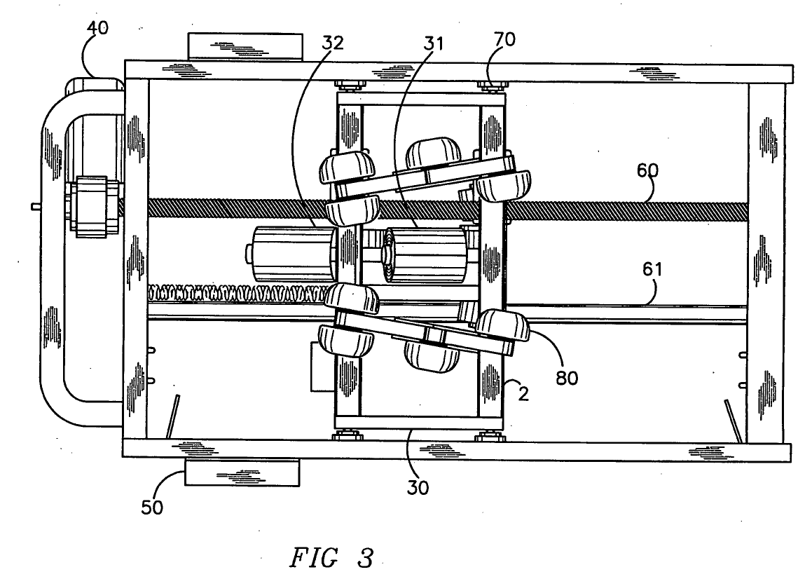

FIG. 3 shows the front view of the present invention with the sliding rack assembly (30) visible, with movement along the stabilizer bar (61) and slide rail guides (43) via slide rail wheels (70) and with upward and downward motions controlled by vertical motor (40) using screw drive (60) and along stabilizer bar (61). Hand like simulated massage movements is achieved with the upper percussion motor assembly (31) combined with use of the lower percussion motor assembly (32).

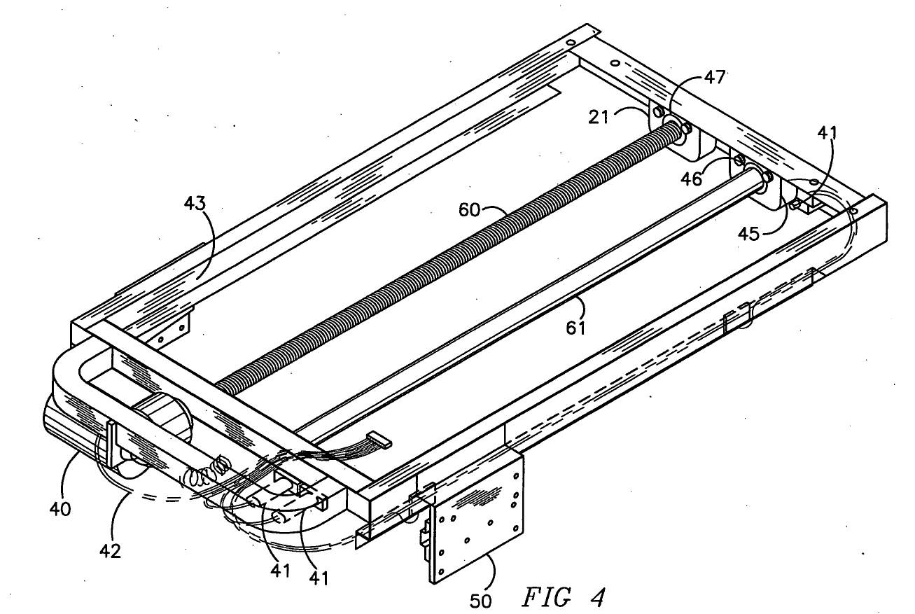

FIG. 4 is a front, right and bottom view of the invention with parts removed to clearly detail the stop switches (41) on the bottom and top ends of the frame structure (51) and controlled via electricity provided via wiring loom (42) in coil for elasticity. Vertical motor (40) provides for motion of sliding rack (30) via screw drive (60) along slide rail guides (43). Screw drive fixing block (21) houses top end of screw drive (60) and screw drive (60) rotates via screw gear (47) stabilizer bar (61) is housed on top end by stabilizer bar locking block (45) and internal stabilizer gear (46). KD Bracket connecting plates (50) on both the right and left sides allow for compatibility and easily coupling to a variety of chairs.

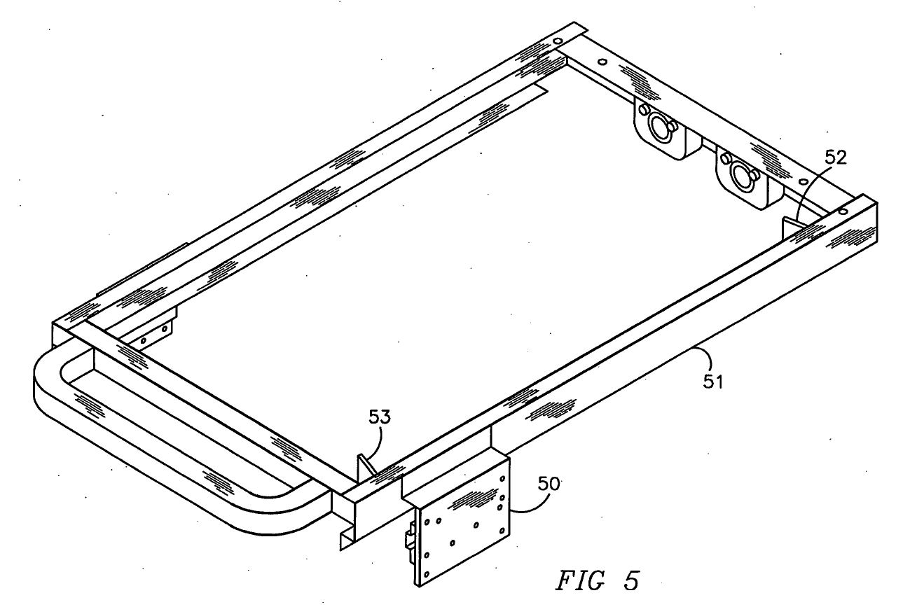

FIG. 5 is a rear, right and bottom view of the invention showing only the frame structure (51) and the KD Bracket connecting plates (50) on both the left and right sides, upper stop block (52) and lower stop block (53).

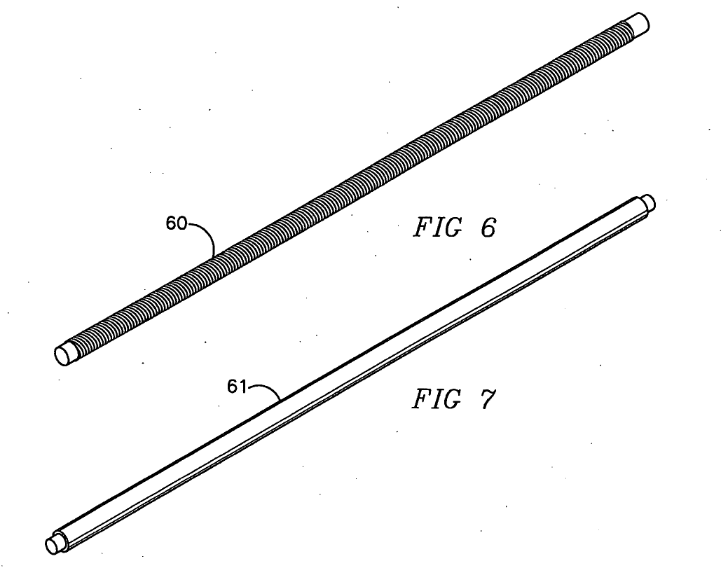

FIG. 6 illustrates the screw drive (60).

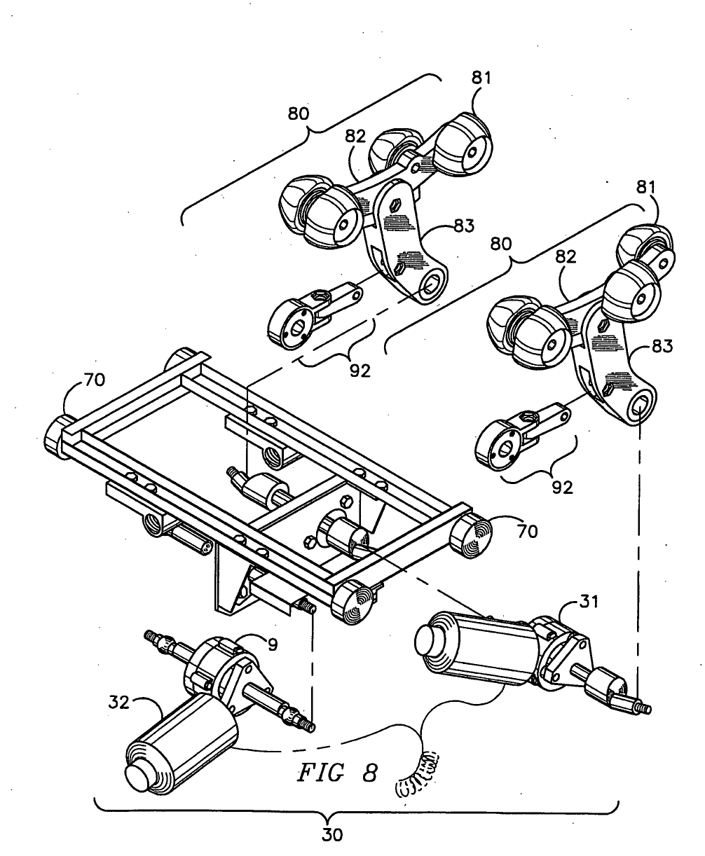

FIG. 7 illustrates the stabilizer bar (61).

FIG. 8 illustrates an exploded view of the sliding rack assembly (30) detailing the upper percussion motor assembly (31) and the lower percussion motor assembly (32). Frictionless movement is provided by slide rail wheels (70) along slide rail guides (43). Percussion and hand massage simulation is achieved through combination of roller wheel assembly (80) including pivot joints (92) coupled to pivot arms (83) and coupled to pivot lever (82) coupled to four massaging “wave” shaped wheels (81) on each roller wheel assembly (80).

FIG. 9 illustrates an exploded view of the roller wheel assembly (80) showing details of pivot lever (82) pivot arm (83) and massaging “wave” shaped wheels (81) and coupling of parts.

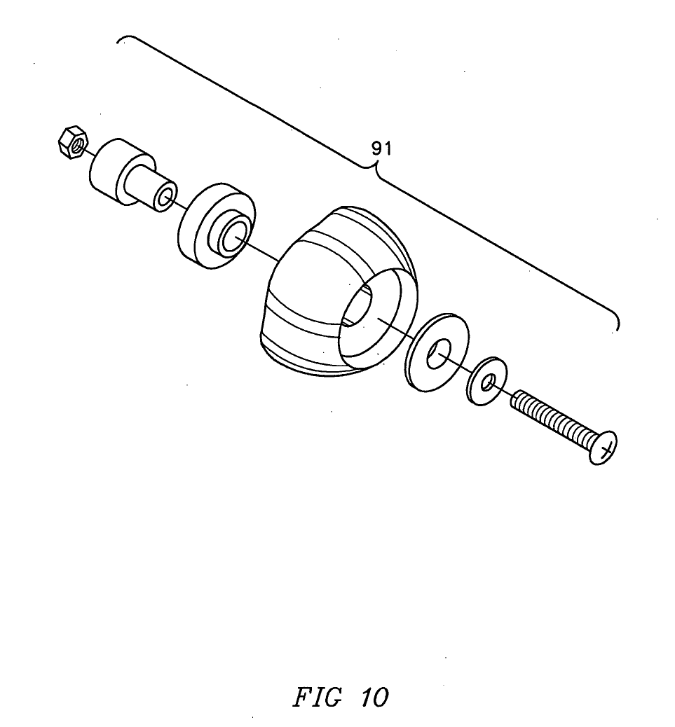

FIG. 10 illustrates an exploded view of massaging wheel assembly (91) showing coupling of parts of massaging “wave” shaped wheel (81).

FIG. 11 illustrates an exploded view of the pivot joint assembly (92) with detailed coupling of off center axis axle (93) coupled to ball joint (95), and covered by joint lid (96) and coupled to axle connecting rod (94).

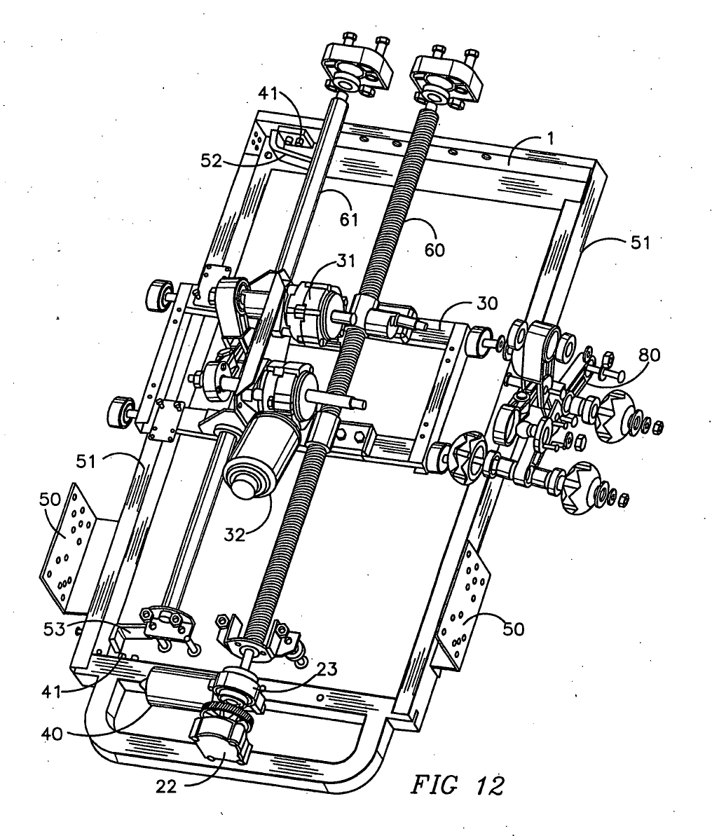

FIG. 12 illustrates a exploded view as seen from the rear, left and bottom view of the entire massage chair servo assembly (1) detailing all parts in detail as shown in FIG. 1 through FIG. 11.

Inside the off center axis axle (93), there is a ball joint (95) which is covered by another joint lid (96). The off center axis axle (93) is connected to the pivot arm (83) via the axle connecting rod (94).

The four (4) roller massaging wheels (81) are installed on the two ends of the pivot lever (82).

The sliding rack (30) moves along the frame structure (51) slide rail guides (43) on the left and right side of the frame structure (51) via the four slide rail wheels (70).

The sliding rack (30) can move up and down via the drive force of the vertical motor assembly (40) and screw drive (60). There is a stabilizer bar locking block (45) on the top of the positioning stabilizer bar (61). The positioning stabilizer bar (61) is fixed on the frame structure (51) via a stabilizer gear (46) inside the locking block (45) of the positioning stabilizer bar (61).

When the sliding rack (30) moves, it is positioned by the positioning stabilizer bar (61) and the slide rail wheels (70) at the two ends of the sliding rack (30). Thus forming the two-front, one-rear three-point positioning system, so that the whole machine is more stable in movement and eliminating the wobbling of the massage chair in working mode, and greatly improving the stability of the chair during operation.

The screw drive (60) is screwed within the screw drive driving block (22) and screw drive stop block (21). There is screw drive gear (23) at the end of the vertical motor assembly (40). There is a motor support lid (24) on the screw drive gear (23). The two ends of the screw drive (60) are installed on the gear (23) and screw drive stop block (21).

At the two inner top and bottom sides of the frame structure (51), there are stop switches (41). At the top and bottom ends of the sliding rack (30), there is surface for contact to the switches (41), which enables the sliding rack (30), when moving to the utmost position either top or bottom, to automatically impact the top and bottom switches (41) thereby causing the sliding rack (30) to either stop or reverse direction depending on the user's selected preferences.

There are KD Bracket connecting plates (50) at the lower two ends of the frame structure (51). Adopting the use of the KD Bracket connecting plates (50) enables for free adjustment of the angle and width for coupling of massage chair servo assembly main rack (1) to a variety and multitude of chairs. As a result, the frame structure (51) can be connected to any compatible KD brackets whereby creating easy coupling with various motion chair systems on the market.

Although particular embodiments of the invention have been described and illustrated herein, it is recognized that modifications may readily occur to those skilled in the art. Consequently, it is intended that the claims be interpreted to cover such modifications and equivalents thereof.

In accordance with a preferred embodiment of the invention, there is disclosed a frame and servo assembly for massage chairs. It includes a frame body, on which there is sliding rack, a screw drive, a positioning stabilizer bar, and connecting plates. This present invention is a frame and servo assembly for massage chair seats manufactured without an existing servo assembly. It includes a frame body, on which there is sliding rack, a screw drive, a positioning stabilizer bar, and a connecting plate.

The sliding rack is coupled to various motor brackets, the screw drive, a driving block, a screw drive stop block, and a plurality of massaging wheels.

There are two motors on the various motor brackets. One of the motors utilizes an axle with an off-center axis on both ends. There are multiple connecting brackets installed on the off-center axle, with wheel brackets installed at the end of the connecting brackets. Various (“wave”) oval ellipsoidal shaped wheels at the end of the wheel brackets aid to simulate the natural feel of human hand joint movements to a user.

At the two ends of the additional motor assemblies are bases for joint assemblies. These joint bases are connected to the connecting brackets via connecting joints.

The wheels are located on the two ends of the sliding rack. The positioning stabilizer bar is affixed inside the frame body for stability.

The screw drive is screwed within the screw drive driving block and screw drive stop block.

The positioning stabilizer bar and the two wheels on both ends of the sliding rack form a three (3) point junction at that location.

Two (2) connecting plates are located on both sides of the frame body. These connecting plates may be attached to any massage chairs with universal “KD” (Knock Down) brackets. Most massage chair assemblies on the market today require a massage chair servo assembly installed before becoming a massage chair. Without installation of such massage chair servo assemblies, as in the present invention, such chairs would simply be chairs and not massage chairs. Such chairs utilize the standard KD bracket system to accommodate coupling to limited choices of massage servo assemblies on the market today.

Still other objects, features, and attendant advantages of the present invention will become apparent to those skilled in the art from a reading of the detailed description of embodiments constructed in accordance therewith, taken in conjunction with the accompanying drawings.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention described by the foregoing includes all changes that come within the meaning, range and equivalence thereof and is intended to be embraced therein.

What is claimed is:

1. A massage chair servo assembly comprising:
a rectangular shaped frame structure having top, bottom, left and right sides,
a sliding rack coupled to said frame structure via slide rail wheels movably attached onto slide rail guides on right and left sides of said frame structure,
connecting brackets on right and left sides of said frame structure,
a “U” shaped tubular structure coupled to said bottom side of said frame structure,
a vertical motor assembly coupled to said “U” shaped tubular structure,
a screw drive having first and second end coupled to said vertical motor assembly coupled to said “U” shaped tubular structure on one end,
said screw drive coupled to said top side of said frame structure at second end of screw drive,
a positioning stabilizer bar having a first and second end wherein said first end is coupled to said bottom side of said frame structure,
said positioning stabilizer bar having said second end coupled to said top side of said frame structure,
said sliding rack is coupled to said screw drive,
said sliding rack is coupled to said positioning stabilizer bar,
wherein said sliding rack is moved upward via said vertical motor assembly,
wherein said sliding rack is moved downward via said vertical motor assembly,
said sliding rack is coupled to an upper percussion motor assembly,
said sliding rack is coupled to a lower percussion motor assembly,
said upper percussion motor assembly is coupled to a first roller wheel assembly via a first pivotally rotating joint,
said lower percussion motor assembly is coupled to a second roller wheel assembly via a second pivotally rotating joint,
wherein said upward and said downward movements are limited by stop switches at both said top and bottom sides of said frame structure,
wherein said upward movement is further limited by an upper stop block coupled to said right side of said frame structure,
wherein said downward movement is further limited by a lower stop block coupled to said right of said frame structure,
whereby a controlled apparatus for providing massage will be provided.

2. The massage chair servo assembly according to claim 1, wherein said connecting brackets are predrilled with holes to accommodate a variety of chair frame assemblies capable of attachment with massage chair servo assemblies.

3. The massage chair servo assembly according to claim 1, wherein said vertical motor assembly coupled to said “U” shaped tubular structure coupled with said screw drive and coupled with said sliding rack of claim 1, provides for upward and downward movements of said sliding rack.

4. The massage chair servo assembly according to claim 1, wherein said first end of positioning stabilizer bar coupled to said bottom side of said frame structure and having said second end of positioning stabilizer bar coupled to said top side of said frame structure provides for stability during said upward and said downward movements of said sliding rack.

5. The massage chair servo assembly according to claim 1, wherein said first roller wheel assembly is comprised of 4 massaging wheels.

6. The massage chair servo assembly according to claim 5, wherein said massaging wheels are of a “wave” shape.

7. The massage chair servo assembly according to claim 6, wherein said “wave” shaped wheels have five evenly spaced indentations, wherein said indentations give rise to five evenly spaced protrusions, whereby human like hand massage is simulated.

8. The massager chair servo assembly according to claim 1, wherein said second roller wheel assembly is comprised of 4 massaging wheels.

9. The massage chair servo assembly according to claim 8, wherein said massaging wheels are of a “wave” shape.

10. The massage chair servo according to claim 9, wherein said “wave” shaped massaging wheels have five evenly spaces indentations, wherein said indentations give rise to five evenly spaced protrusions, whereby human like hand massage is simulated.

11. A method of fabricating a stable massage chair apparatus, comprising selecting a massage chair frame of adequate height and width to accommodate a massage chair servo assembly.

12. The method of claim 11, further comprising attaching said massage chair frame in a desired orientation with said massage chair servo assembly via KD brackets.

13. The method of claim 12, wherein the indicating steps comprise placing said massage chair frame with said massage chair servo assembly in alignment using said KD brackets for secure attachment.

14. The method of claim 13, wherein the indicating steps comprise coupling said massage chair frame to said massage chair servo via KD brackets whereby a coupling is securely fastened by a combination of bolts, washers and nuts.

15. The method of claim 14, wherein the indicating steps comprise powering said massage chair servo is by electricity by way of an outlet.

16. The method of claim 15, further comprising selecting the desired combination of massaging motions, intensity and duration of said massaging motions using an attached control unit.
